(19) United States
(12) Patent Application Publication
(10) Pub. No.: US 2005/0183553 A1
(43) Pub. Date: Aug. 25, 2005

(54) Seat installation tool

(76) Inventor: Deborah F. Dawson, Anaheim Hills, CA (US)

Correspondence Address: Elliott N. Kramsky, Esq., Suite 400, 5850 Canoga Avenue, Woodland Hills, CA, 91367, US

(21) Appl. No.: 10/781,835

(22) Filed: Feb. 20, 2004

(51) Int. Cl. B25B 33/00; A47C 7/02

(52) U.S. Cl. 81/488

(57) ABSTRACT

A tool for installation of an auxiliary seat of the type that includes a transverse channel for receiving a seat belt. An elongated unitary member includes hooks adjacent its opposed ends. Each hook lies within one of two orthogonal planes with the maximum dimension of one hook being less than the height and that of the other hook being less than the width of the transverse channel.

### BACKGROUND

1. Field of the Invention

The present invention relates to devices for facilitating the installation of a child safety seat in an automobile. More particularly, this invention pertains to a tool consisting of a single integral member for threading a seat belt through the transverse channel commonly associated with such a safety seat.

2. Description of the Prior Art

A common design for an automobile baby seat includes a base having a transverse channel for receiving a seat belt of the lap or shoulder type in a tie-down arrangement. After passing through the channel, the seat belt, which terminates in a metal engagement plate, is then coupled to a mating buckle.

Automobile seat belts are commonly of fabric or synthetic material, terminating, as mentioned earlier, in a metal plate designed to interlock with a buckle. The buckle may be located at either end of a strip of fabric or synthetic material or be fixed directly to the automobile. In either case, the near-universal presence of a seat belt provides a logical invitation to design baby seats upon the assumption that the seat belt will provide attachment to the seat of the automobile.

Often, the seat belt is engaged to a spring-driven retraction mechanism. Such a mechanism applies continuous tension to take up unneeded belt length and to retract the belt completely when not required. Such a conventional seat belt arrangement complicates baby seat installation. The transverse channel at the base of the seat is generally of inadequate size to allow an adult to insert his or her forearm and hand to sufficient channel depth to permit grasping of the end of the belt for threading it through the transverse channel. This is further complicated by the presence of the above-described retraction mechanism. As a result, the baby seat installation process often poses a vexing task capable of soiling or even causing physical harm to an installer required to assume awkward hand and arm positions, kneel on the ground, etc. Muscle strains, torn garments, even back injuries, may be experienced by an installer without proper tools.

A number of efforts have been made in the past to deal with the problems encountered during baby seat installation. Included among these are devices disclosed in U.S. Pat. No. 5,197,176 of Reese for “Seat Belt Guide Useful in Securing a Child Safety Restraint” and U.S. Pat. No. 5,496,083 of Shouse for “System For Installing Automobile Baby Seats”.

### SUMMARY OF THE INVENTION

The present invention provides, in a first aspect, a tool for installation of an auxiliary seat of the type that includes a transverse channel having a length, height and width for receiving a seat belt of the type that includes a plate having an aperture at the free end thereof.

The tool comprises an elongated member. A first hook and a second hook are located at opposed ends of the elongated member.

In a second aspect, the invention provides apparatus for installation of an auxiliary seat. Such apparatus includes an elongated member and means integral with the elongated member at one end of the elongated member for grasping a plate located at the free end of a seat belt at an internal aperture.

The invention will become further apparent from the detailed description that follows. Such description is accompanied by a set of drawing figures. Numerals of the drawing figures, corresponding to those of the written description, point to the features of the invention with like numerals referring to like features throughout both the written description and the drawing figures.

### BRIEF DESCRIPTION OF THE DRAWINGS

FIGS. 1(a) and 1(b) are orthogonal side elevation views of a tool in accordance with the invention;

FIGS. 2(a) and 2(b) illustrate the operation of a tool in accordance with the invention; and

FIG. 3 is a front elevation view of a tool in accordance with the invention positioned with respect to the transverse channel of an auxiliary seat.

### DETAILED DESCRIPTION OF THE PREFERRED EMBODIMENT

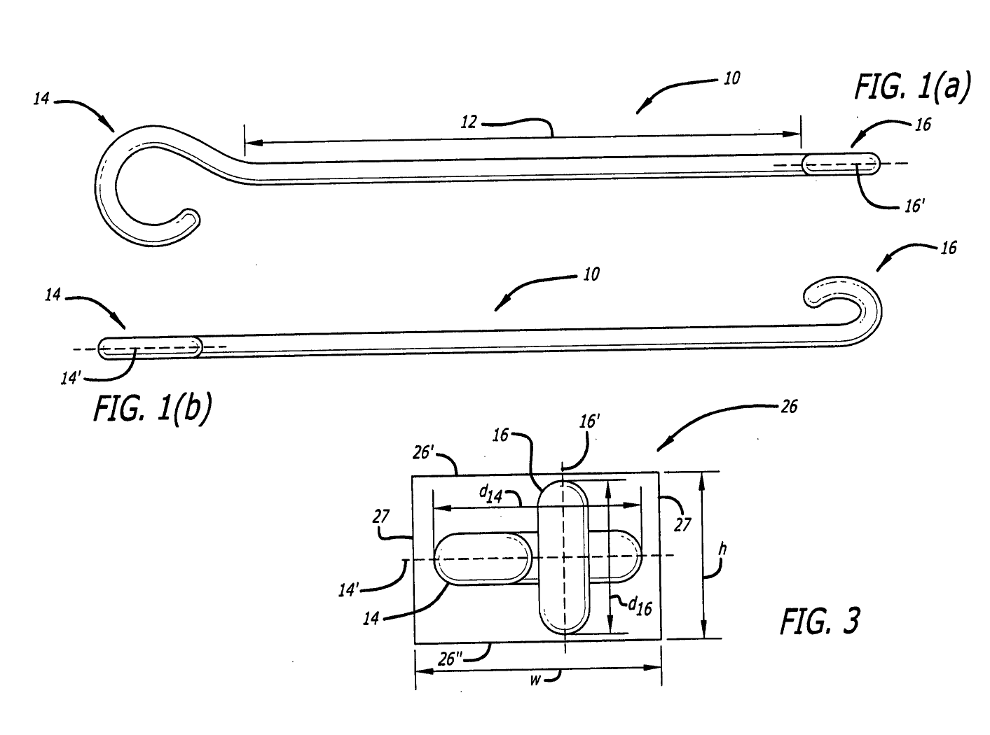

Turning now to the drawings, FIGS. 1(a) and 1(b) are orthogonal side elevation views of a tool 10 in accordance with the invention. The tool 10 comprises an integral member suitable for grasping and guiding the free end of a vehicle seat belt through the transverse channel that is typically found in an auxiliary seat for a child. Such a channel permits the seat belt to act as a tie-down for securing the auxiliary seat to the front or rear seat of the vehicle.

As is well, known, vehicle seat belts are typically of standardized design and dimensions and adapted to cooperated with a locking mechanism. One end of the belt (typically of fabric) is permanently anchored to the vehicle with an opposed, free end terminated with a plate-like element that has an internal aperture for engaging an interlocking receptacle. Such a receptacle may be fixed either to the vehicle or to the free end of a (typically fabric) belt that is fixed to the vehicle. The receptacle typically includes a spring-loaded mechanism arranged to secure the plate-like element at the internal aperture when the element is inserted.

The tool 10 of the invention is generally elongated, preferably formed of durable plastic or metal, and consists of a substantially-straight elongated member 12 that is terminated at its opposed ends by hooks 14 and 16 formed integrally therewith. As can be seen from the orthogonal views of FIGS. 1(a) and 1(b), the two hooks 14, 16 are substantially mutually orthogonal. That is, each is of essentially planar symmetry with the plane 14′ (shown in edge view in FIG. 1(b)) of the hook 14 and the plane 16′ (shown in edge view in FIG. 1(a) of the hook 16 being mutually orthogonal.

As mentioned earlier, vehicle seat belts are typically of standardized design, operation and dimensions. Thus the sizes of the length and cross-section (i.e., height and width) of the transverse channel of an auxiliary seat are predictable. It will be seen below that this permits sizing of the critical dimension of the tool 10 for operation in conjunction with auxiliary seats from various sources and manufacturers.

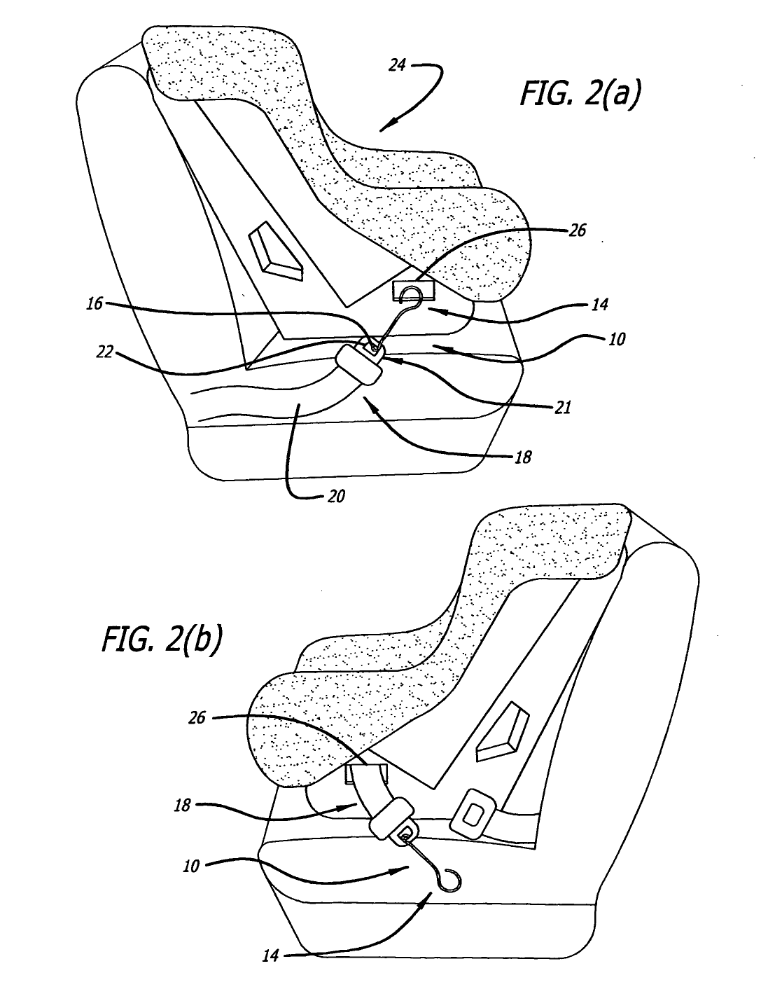

FIGS. 2(a) and 2(b) illustrate the operation of the tool 10. The discussion of such operation will be accompanied by occasional reference to FIG. 3 which presents a front elevation view of the tool 10 positioned with respect to a transverse channel of an auxiliary seat of height “h” and width “w”.

The tool 10 is of a simple design that permits economical manufacture and a product of consequently low cost. As shown in FIG. 2(a), a seat belt 18 includes a fabric member 20 having one end fixed to the vehicle (not shown) with the opposed, free end terminating in a plate-like member 21 that includes an internal aperture 22.

An auxiliary seat 24 has a transverse channel 26. As mentioned above, the length, height and width of such an auxiliary seat 24 are relatively standardized.

The tool 10 is shown in FIG. 2(a) positioned prior to travel through the transverse channel 26 of the auxiliary seat 24. As can be seen, the hook 16 of the tool 10 is engaged to the plate-like member 20 at the internal aperture 22 while the hook 14 is positioned so that the plane 14′ thereof lies parallel to the top 26′ and bottom 26″ of the transverse channel 26. Alternatively, should the relative dimensions (height, width) of the transverse channel 26 permit, the tool 10 may be positioned as shown in FIG. 2(a) prior to passage of the belt through the channel 26 with the plane 14′ of hook 14 parallel to the sides 27 of the transverse channel 26.

Once the tool 10 is appropriately positioned with respect to the cross-sectional dimensions of the transverse channel 26, the tool 10, whose length exceeds the length of the transverse channel 26, may be inserted into the channel 26. As the hook 16 is coupled to the plate-like member 21, the belt 20, whose opposed end is typically engaged to a tension-actuated extension mechanism (not shown), will follow the travel of the tool 10.

Travel of the tool 10 through the transverse channel 26 is possible due to the sizes of the the hooks 14 and 16 relative to the cross-sectional dimensions h, w of the transverse channel 26. As can be seen clearly in FIG. 3, the maximum dimension d₁₄ of the hook 14 in the plane 14′ is somewhat less than w, the width of the transverse channel 26. At the same time, the maximum dimension d₁₆ of the hook 16 in the plane 16′ is less than h, the height h of the transverse channel 26. It will be understood that a like result may be obtained through appropriate sizing of the hooks 14 and 16 relative to the cross-sectional dimensions h and w of the transverse channel. Furthermore, the invention may also be adapted to accommodate transverse channels characterized by cross-sections of various shapes including, for example, a circular cross section. In such a case (referring to the nomenclature of FIG. 3), w and h are equal and design of the tool 10 (i.e. sizing of the hooks 14 and 16) may proceed as before.

FIG. 2(b) illustrates the tool 10 and belt 18 upon passage through the transverse channel 26. The attitude of the tool 10 and belt 18, relative to their “entry” attitude as illustrated in FIG. 2(a) after the rigid tool 10 as been pushed into the channel 26 from the entry attitude of FIG. 2(a), then pushed through the channel 26 to emerge in the “exit” attitude illustrated in FIG. 2(b). As mentioned earlier, the length of the tool 10 is sized to exceed that of the transverse channel 26. This permits the tool 10 to be controlled initially at the end that hooks onto the plate-like member 21 (configuration of FIG. 2(a)) so that the tool 10 and belt 18 can be pushed into and through the channel 26 and then controlled (i.e. dragged or pulled) from its opposed end upon emergence from the other end of the transverse channel 26 as illustrated in FIG. 2(b).

Thus, it is seen that the present invention provides a tool of simple character and correspondingly economical manufacture and cost for installation of an auxiliary seat of conventional design in a vehicle. By employing the tool, one may readily thread the free end of a seat belt through the transverse channel that characterizes such an auxiliary seat.

While this invention has been described with reference to its presently preferred embodiment, it is not limited thereto. Rather, this invention is limited only insofar as it is defined by the following set of patent claims and includes within its scope all equivalents thereof.

1. A tool for installation of a seat of the type that includes a transverse channel having a length, height and width for receiving a seat belt of the type that includes a plate having an aperture at a free end thereof, said tool comprising an integral rod forming (i) an elongated straight member, the length of said member exceeding that of said channel, (ii) a first generally arcuate hook and a second generally arcuate hook at opposed ends of and integral with the elongated member, said first hook lying in a first plane and said second hook lying in a second plane orthogonal to said first plane and (iii) said first hook being of lesser maximum dimension orthogonal to the length of said elongated member than the height of said transverse channel and said second hook being of lesser maximum dimension orthogonal to said elongated member than the width of said transverse channel.

2. (canceled)

3. (canceled)

4. (canceled)

5. (canceled)

6. A tool as defined in claim 1 of plastic composition.

7. (canceled)

8. (canceled)

9. (canceled)

10. A system for selectively securing an auxiliary seat to an automobile seat having an associated two-part seat belt, one end of a first part of said seat belt being fixed to said automobile and the opposed end comprising a plate-like member having an internal aperture, one end of a second part of said seat belt being fixed to said automobile and the opposed end comprising a clip for selectively mating said plate-like member, said system comprising, in combination:
a) said auxiliary seat including a transverse channel for receiving said seat belt in tie-down relationship, said channel having a length, a height and a width;
b) a tool for guiding said free end of said first part of said seat belt through said transverse channel, said tool comprising an integral rod comprising (i) an elongated straight member, the length of said member exceeding that of said channel and (ii) a first generally arcuate hook and a second generally arcuate hook at opposed ends of and integral with the elongated member, said first hook lying in a first plane and said second hook lying in a second plane orthogonal to said first plane; and
c) said first hook being of lesser maximum dimension orthogonal to the length of said elongated member than the height of said transverse channel and said second hook being of lesser maximum dimension orthogonal to said elongated member than the width of said transverse channel.
